(19) United States
(12) Patent Application Publication
(10) Pub. No.: US 2021/0099470 A1
(43) Pub. Date: Apr. 1, 2021

(54) INTRUSION DETECTION DEVICE AND INTRUSION DETECTION METHOD

(71) Applicant: INSTITUTE FOR INFORMATION INDUSTRY, TAIPEI (TW)

(72) Inventors: Chih-Ta LIN, Taipei (TW); Ding-Jie HUANG, Taipei (TW); Mei-Ling LEE, Taipei (TW); Yu-Ting TSOU, Taipei (TW)

(21) Appl. No.: 16/790,699

(22) Filed: Feb. 13, 2020

(30) Foreign Application Priority Data
Sep. 27, 2019 (CN) 201910926721.8

(51) Int. Cl. H04L 29/06

(52) U.S. Cl. CPC H04L 63/1416; H04L 63/0263

(57) ABSTRACT

An intrusion detection device includes a connection interface and a processor. The processor is configured to obtain a network protocol data and an industrial operation data of each of the plurality of first packets; tag a first internet protocol (IP) address of the network protocol data with a first action role and tag a second internet protocol (IP) address of the network protocol data with a second action role respectively; obtain a related group of the first IP address, wherein the related group comprises a first industrial device information and a second industrial device information; and generate a rule list, wherein the rule list comprises the first action role, the first IP address, the second IP address, and contents of the related group, which the first action role on the rule list corresponds to the first industrial device information and the second industrial device information.

### CROSS-REFERENCE TO RELATED APPLICATION

This application claims priority to and the benefit of Chinese patent application No. 201910926721.8, filed on Sep. 27, 2019, the entire content of which is incorporated herein by reference as if fully set forth below in its entirety and for all applicable purposes.

### BACKGROUND

### Field of Disclosure

The disclosure generally relates to detection devices and method, and more particularly, to an intrusion detection device and method at network packets.

### Description of Related Art

An industrial control system usually applies master-slave architecture (such as Modbus). However, the property of master-slave architecture results in vulnerabilities of information security issues of a system. For example, a hacker can disguise itself as a master device) to make a masquerading packet being transmitted to a slave device, and it will result in the invasions of the slave devices and many industrial devices that are connected with the slave devices.

However, the intrusion detection system (IDS) nowadays only defines detection rules in contents of layer 3 and layer 4 of Open System Interconnection Reference Model (OSI) which results in the industrial control system for Modbus is not capable of being protected in information security. Therefore, it is desirable to have a solution for preventing the industrial control system from being attacked outside and inside.

### SUMMARY

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

One aspect directed towards an intrusion detection device which is suitable for Modbus. The intrusion detection device includes a connection interface and a processor. The processor is configured to receive a plurality of first packets through the connection interface. The processor is configured to obtain a network protocol data and an industrial operation data of each of the first packets; tag a first internet protocol (IP) address of the network protocol data with a first action role and tag a second internet protocol (IP) address of the network protocol data with a second action role respectively; obtain a related group of the first IP address, wherein the related group comprises a first industrial device information and a second industrial device information; and generate a rule list, wherein the rule list comprises the first action role, the first IP address, the second IP address, and contents of the related group, and the first action role on the rule list corresponds to the first industrial device information and the second industrial device information.

One aspect directed towards an intrusion detection method, which is suitable for the network architecture of Modbus. The intrusion detection method includes the steps of receiving a plurality of first packets and obtaining a network protocol data and an industrial operation data of each of the first packets; tagging a first internet protocol (IP) address of the network protocol data with a first action role and tagging a second internet protocol (IP) address of the network protocol data with a second action role respectively; obtaining a related group of the first IP address, wherein the related group comprises a first industrial device information and a second industrial device information; and generating a rule list, wherein the rule list comprises the first action role, the first IP address, the second IP address, and contents of the related group, and the first action role on the rule list corresponds to the first industrial device information and the second industrial device information.

It is to be understood that both the foregoing general description and the following detailed description are by examples, and are intended to provide further explanation of the disclosure as claimed.

### BRIEF DESCRIPTION OF THE DRAWINGS

FIG. 1 is network architecture of an industrial control system for adapting an intrusion detection device in accordance with some aspects of the present disclosures.

FIG. 2 is a flow chart illustrating an intrusion detection method in accordance with some aspects of the present disclosure.

FIG. 3 is a flow chart illustrating the intrusion detection method in accordance with some other aspects of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

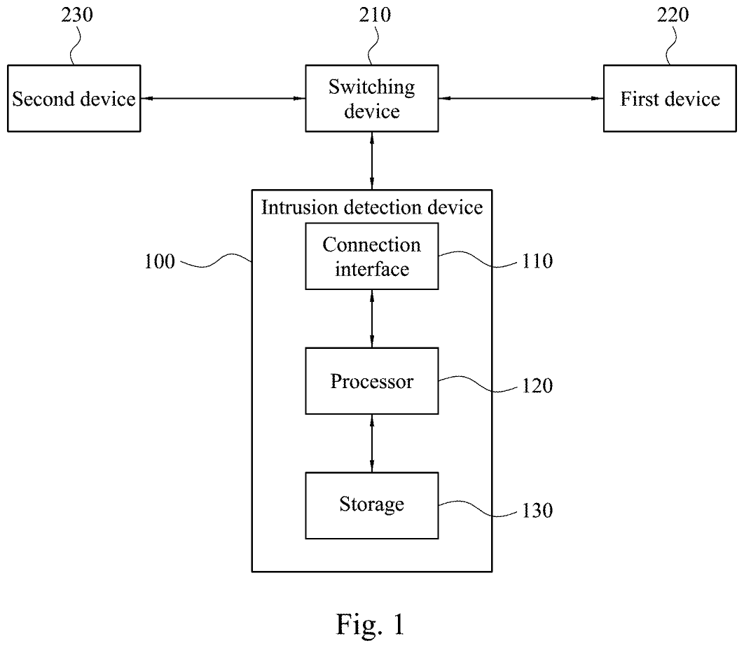

Reference is made to FIG. 1, which is network architecture of an industrial control system for adapting an intrusion detection device 100 in accordance with some aspects of the present disclosures. As shown in FIG. 1, the industrial control system comprises, for example, the intrusion detection device 100, a switching device 210, a first device 220, and a second device 230. In some embodiments, the switching device 210 is disposed between the first device 220 and the second device 230 for relaying packets such that the packets are transmitted from the first device 220 to the second device 230 and/or from the second device 230 to the first device 220. The switching device 210 can be a switch device with a sniffing function. In one embodiment, the packets, which are transmitted between the first and second devices 220/230 in network architecture of FIG. 1, are supervised. In another embodiment, the switching device 210 can supervise the packets transmitted from other switching device and other network device.

The intrusion detection device 100 includes a connection interface 110, a processor 120, and a storage 130. In some embodiments, the switching device 210 includes a monitor port (such as a connection interface between the switching device 210 and the intrusion detection device 100) and a mirroring port (such as a connection interface between the switching device 210 and the first device 220 and a connection interface between the switching device 210 and the second device 230). The monitor port of the switching device 210 connects to the connection interface 110 such that the intrusion detection device 100 can receive all duplicate packets which are relayed by the switching device 210 in order to supervise network activities. It should be noted that the network architecture of the industrial control system shown in FIG. 1 is taken as an exemplary illustration for network architecture, and the number of the switching device 210, the first device 220, and the second device 230 can be changed according to practices. Any network architecture where the duplicate packets can be sniffed by the intrusion detection device 100 belongs to the disclosure.

In some embodiments, the intrusion detection device 100 is suitable for the network architecture of Modbus. For example, the first device 210 is coupled to some industrial devices (not shown), and the industrial devices are configured for the network architecture of Modbus. The packets, which are transmitted between the first device 220 and the second device 230, have communication stacks of the Transmission Control Protocol/Internet Protocol (TCP/IP) which are performed as a lower layer protocol (such as related to the first layer to the fourth layer of OSI model), and have the communication stacks of Modbus which are performed as a higher layer protocol (such as related to the fifth layer to the seventh layer of OSI model).

The storage 130 is coupled to the processor 120. The processor 120 analyses the duplicated packets to generate statistic data, event logs, a rule list, and so on. The storage 130 is configured to store statistic data, event logs, a rule list, and data stored thereon is not limited herein.

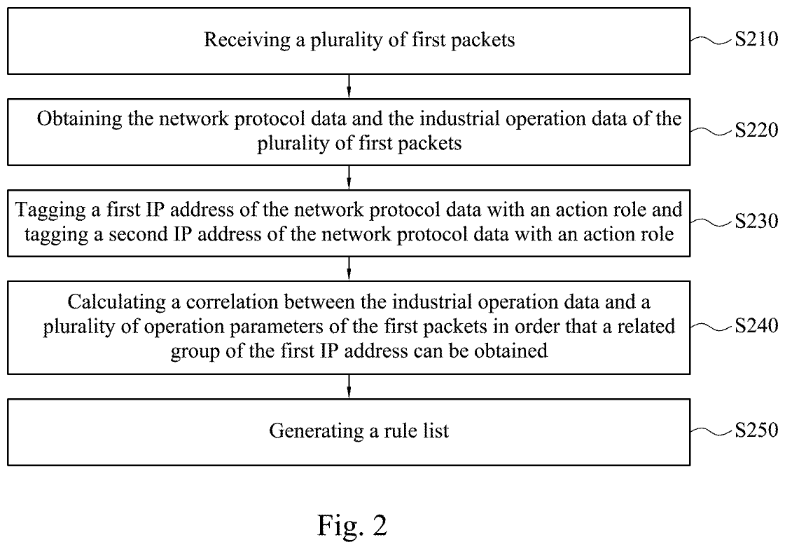

Reference is made to FIG. 2, which is a flow chart illustrating an intrusion detection method in accordance with some aspects of the present disclosure. In some embodiments, the intrusion detection method can be performed by the intrusion detection device 100 of FIG. 1.

As shown in FIG. 2, in step S210, the processor 120 receives a plurality of duplicate packets (hereinafter referred to as ‘first packets’) through the connection interface 110.

In some embodiments, the first packets include network protocol data and industrial operation data. The network protocol data can be, but is not limited to, an internet protocol (IP) address and a communication port of the transmission control protocol (TCP).

In step S220, the processor 120 obtains the network protocol data and the industrial operation data of the plurality of first packets.

In some embodiments, the network protocol data of the first packets include a first internet protocol (IP) address and a second internet protocol (IP) address. For example, the first packets include a source address which represents a source device which has transmitted the packets. The first packets further include a destination address which represents a destination device that will receive the packets.

In some embodiments, the network protocol data of the first packets includes a first communication port and a second communication port. For example, the first communication port can be the communication port of the source device, and the second communication port can be the communication port of the destination device.

In some embodiments, the industrial operation data can be a function code, an operation parameter, or other parameters of Modbus protocol. The function code is, for example, a parameter specified by the Modbus protocol. The related statement of Modbus can be referred to Modbus protocol specification.

In some embodiments, the processor 120 has received the first packets for a period of time (such as for one hour), and contents of the first packets are further statistically analyzed according to deep packet inspection. An inspection result is shown below in TABLE 1.

TABLE 1
Packets' contents

| | Source | Source | | Destination | Destination | Destination | Protocol | Number of | |
|---|---|---|---|---|---|---|---|---|---|
| Time | IP address | port | Source Mac | IP address | port | Mac address | Number | connections | Bytes |
| 05:31:41 | 192.168.1.23 | any | 00.10.F3.4F.9E.C4 | 192.168.1.19 | 502 | 00.D0.C9.F8.B5.3F | 502 | 114 | 5280 |
| 05:31:42 | 192.168.1.19 | 502 | 00.D0.C9.F8.B5.3F | 192.168.1.23 | any | 00.10.F3.4F.9E.C4 | 502 | 85 | 4154 |
| 05:31:52 | 192.168.1.23 | any | 00.10.F3.4F.9E.C4 | 192.168.1.55 | 502 | 00.03.7B.C0.19.7F | 502 | 341 | 16952 |
| 05:31:55 | 192.168.1.55 | 502 | 00.03.7B.C0.19.7F | 192.168.1.23 | any | 00.10.F3.4F.9E.C4 | 502 | 277 | 15478 |

After the intrusion detection device 100 obtains the network protocol data and the industrial operation data of the plurality of first packet, in step S230, the processor 120 tags a first IP address of the network protocol data with an action role and tags a second IP address of the network protocol data with an action role respectively.

In some embodiments, the storage 130 stores a look-up table. The look-up table includes a plurality of communication ports and the action role corresponding to each communication port. For example, as shown in TABLE 2, a service content of a communication port number 502 is related to Modbus and the action role of the communication port number 502 is a first level. A service content of a communication port 587 is related to SMTP (Simple Mail Transfer Protocol) and the action role of the communication port 587 is a fourth level, and so on.

TABLE 2
Action roles

| Communication port | Protocol Type | Action role |
|---|---|---|
| 427 | SLP | Office computer |
| 443 | HTTPS | Office computer |
| 445 | SMB | Office computer |
| 465 | SMTP | Office computer |
| 502 | Modbus | Controller |
| 514 | Syslog | Office computer |
| 530 | RPC | Office computer |
| 546 | DHCP v6 Client | Office computer |
| 547 | DHCP v6 Server | Office computer |
| 554 | RTSP | Office computer |
| 585 | IMAPS | Office computer |
| 587 | SMTP | Office computer |
| 636 | LDAPS | Office computer |
| 902 | Vmware | Office computer |

In some embodiments, the communication ports and the action role corresponding to each communication port in TABLE 2 are defined based on the Purdue model.

As shown below in TABLE 3, the first level represents that the device is a controller, a second level represents that the device is a control center, a third level represents that the device is database, the fourth level represents that the device is the office computer, and a fifth level represents that the device is a server. It should be noted that the Purdue model is applied to design the action roles in the disclosure, and the contents of TABLE 2 can be modified according to practices. Furthermore, the Purdue model is a means of Operational Technology (OT) which is used widely, and the detailed description of the Purdue model is eliminated in the disclosure.

TABLE 3
Levels of Purdue model

| Levels of Purdue model | Action role |
|---|---|
| First level | Controller (slave device) |
| Second level | Control center (master device) |
| Third level | Database |
| Fourth level | Office computer |
| Fifth level | Server |

In some embodiments, the device with the communication port number 502 is a slave device of Modbus architecture, or called Programmable Logic Controller (PLC) device. In another embodiment, the device with the communication port number (such as any port or a dynamic port which is not registered for standard usage) is a master device of Modbus architecture.

In some embodiments, as shown above in TABLE 2 and TABLE 3, after the processor 120 analyzes the first packets and acquires information of the first packets. For example, the first IP address of the first packets (such as the source IP address) is 192.168.1.23, the first communication port of the first packets (such as the source communication port) is any port, the second IP address of the first packets (such as the destination IP address) is 192.168.1.55, and the second communication port of the first packets (such as the destination communication port) is 502. The processor 120 tags the action role of the first IP address with the controller according to the look-up table, such as TABLE 2.

In another embodiment, the processor 120 tags the action role of the second IP address according to the action role of the first IP address. The description below follows above embodiment. The device which has the IP address 192.168.1.23 will connect to the device which has the IP address 192.168.1.55, which can be known according to the first packets. Since the IP address 192.168.1.23 has been tagged with the controller, and an action role of the device which connects to the controller (or called a slave device) has to be a control center (or called a master device), the action role of the IP address 192.168.1.55 (the second IP address) is the control center, which is deduced from the information above.

In step S240, the processor 120 calculates a correlation between the industrial operation data and a plurality of operation parameters of the first packets in order that a related group of the first IP address can be obtained.

In some embodiments, the operation parameters are configured to operate a plurality of industrial devices connected with the first device 220 based on Modbus. For example, the industrial devices which are configured in a water level control system are a water valve, a pump, a water level sensor, and so on. The operation parameters are a water valve switch parameter, a pump rotation speed parameter, a water level sensing parameter, and so on. For another example, the industrial devices which are configured in an air quality control system are a fan switch, a fan, a carbon dioxide sensor, and so on. The operation parameters are a fan switch parameter, a fan rotation speed parameter, a carbon dioxide sensor parameter, and so on.

Because the intrusion detection device 100 obtains the network protocol data and the industrial operation data of the plurality of the first packets, an industrial device group will be generated by calculating a correlation among the operation parameters. The operation parameters are grouped together with respect to the correlation, for example, the operation parameters with the high correlation are grouped together. For example, the water valve switch parameter, the pump rotation speed parameter, the water level sensing parameter are classified as a first group, and the fan switch parameter, the fan rotation speed parameter, and the carbon dioxide sensor parameter are classified as a second group. The first group and the second group are shown below as TABLE 4 and TABLE 5.

TABLE 4
The first group

| IP address of | PLC address (PLC_addr) | State related |
|---|---|---|
| the second | of the first | to the first |
| device | industrial device | industrial device |
| 192.168.1.55 | 1000 | 0 |
| 192.168.1.55 | 1000 | 0 |
| 192.168.1.55 | 1000 | 1 |
| 192.168.1.55 | 1000 | 1 |
| . . . | . . . | . . . |

TABLE 5
The second group

| IP address of | PLC address of the | State related to | Trend related to |
|---|---|---|---|
| the second | second industrial | the second | the second |
| device | device (PLC_addr) | industrial device | industrial device |
| 192.168.1.55 | 10 | 1 | 2 |
| 192.168.1.55 | 10 | 2 | 1 |
| 192.168.1.55 | 10 | 4 | 1 |
| 192.168.1.55 | 10 | 6 | 2 |
| . . . | . . . | . . . | . . . |

Discrete degree among the industrial device groups is analyzed. The low discrete degree will be classified as the same related group. For example, as shown in TABLE 6, the first group and the second group are related to the same IP address 192.168.1.55, therefore the first group and the second group will be classified as the same related group. It should be noted that the embodiment takes two groups as an example. However, the number of groups is not limited herein. The state in TABLE 4 and TABLE 5 means a parameter range of the industrial device. For example, the values of the water valve switch parameter, the pump rotation speed parameter, the water level sensing parameter, the fan switch parameter, the fan rotation speed parameter, the carbon dioxide sensor parameter is divided into 10 segments (1˜10). The trend in TABLE 4 and TABLE 5 means the variation trend of the parameters of industrial device (such as the parameters described above). For example, the variation trend is decreasing or increasing values.

TABLE 6
related group

| | PLC address | State related | PLC address | State related | Trend related |
|---|---|---|---|---|---|
| IP address of | of the first | to the first | of the second | to the second | to the second |
| the second | industrial device | industrial | industrial device | industrial | industrial |
| device | (PLC_addr) | device | (PLC_addr) | device | device |
| 192.168.1.55 | 1000 | 0 | 10 | 1 | 2 |
| 192.168.1.55 | 1000 | 1 | 10 | 2 | 1 |
| 192.168.1.55 | 1000 | 0 | 10 | 4 | 1 |
| 192.168.1.55 | 1000 | 1 | 10 | 6 | 2 |
| . . . | . . . | . . . | . . . | . . . | . . . |

In some embodiments, the related group includes information of at least one industrial device. As shown in TABLE 6, the related group includes information of a first industrial device and a second industrial device. The information of the industrial device is, for example, the parameters of the industrial device which are described above.

In step S250, the processor 120 generates a rule list. In one embodiment, the rule list includes the action role, the first IP address, the second IP address, and the related group.

In some embodiments, the related group includes a plurality of subrules. As shown in TABLE 6 above, a first subrule is “(PLC_addr=1000 & state=0) & (PLC_addr=10 & state=1 & trend=2)”, a second subrule is “(PLC_addr=1000 & state=1) & (PLC_addr=10 & state=2 & trend=1)”, and so on.

The processor 120 has recorded the IP addresses in step S240. Hence the processor 120 will generate a rule according to the plurality of subrules and the IP addresses. For example, the rule is “(Master in [192.168.1.23] any>[192.168.1.55] 502) & (PLC_addr=1000 & state=0) & (PLC_addr=10 & state=1 & trend=2)”. The rule is described below. First, the rule represents that the IP address of the master device is 192.168.1.23, and the communication port of the master device is any port. The master device transmits a packet which has the IP address 192.168.1.55 and the communication port 502 to the slave device. Furthermore, the packet is configured to set the industrial device which has PLC address “1000” to act as an operation action “state=0”, and to set the industrial device which has PLC address “10” to act as an operation action “state=1 & trend=2”. Therefore, the rule list includes the plurality of rules.

In some embodiments, in each rule of the rule list, the action role (such as the master device) corresponds to the subrules (such as the information of the first industrial device and the information of the second industrial device).

In another embodiment, referring together with step S240 and step S250, after the processor 120 obtains the IP addresses, the communication ports and the action role of the first device 220 and the second device 230, a rule of OT protocol action, such as “alter tcp ! [192.168.1.23] any->192.168.1.55 502”, is generated. The rule of OT protocol action is used for determining the packet's content. The packet can be determined that it has not satisfied the rule if any one of the following condition is true: the source IP address is not “192.168.1.23”, the source communication port is not any port, the destination IP address of the packet is not “192.168.1.55”, and the destination communication port of the packet is not 502. Meanwhile, the processor 120 will generate the rule of the OT operation action, such as “(msg: “Modbus TCP/Write Single Coil”; content: “|00 00|”; offset:2; depth:2; content: “|06|”; offset:7; depth:1; sid:100;)”. The processor 120 merges the rule of OT protocol action with the rule of OT operation action to generate the rule of the rule list. The rule is, for example, “alert tcp ![192.168.1.23] any->192.168.1.55 502 (msg: “Modbus TCP/Write Single Coil”; content: “|00 00|”; offset:2; depth:2; content:“|06|”; offset:7; depth: 1; sid: 100;)”.

It should be noted that the rule list can be, but is not limited to, a whitelist or a blacklist that can be used to allow or filter a packet. In some embodiments, the whitelist is taken as an example of the rule list. However, it is not limited herein.

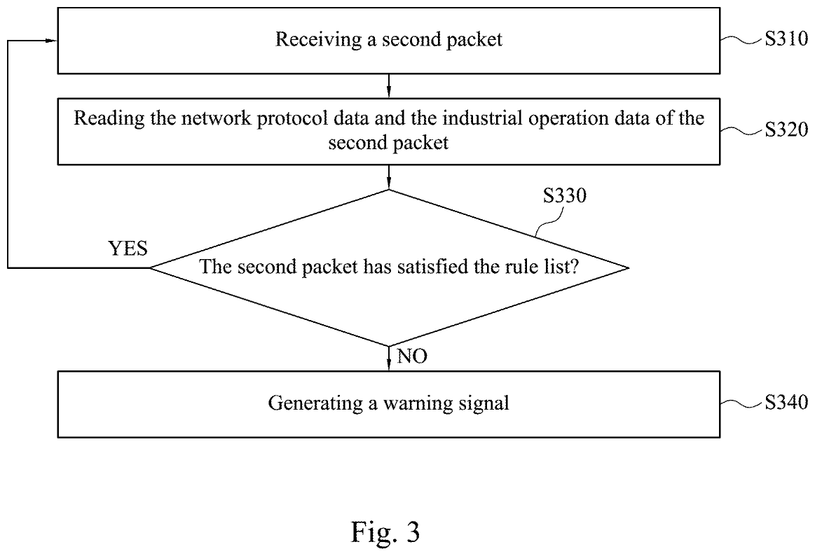

Reference is made to FIG. 3, which is a flow chart illustrating the intrusion detection method in accordance with some other aspects of the present disclosure. The intrusion detection method is performed by the intrusion detection device 100 of FIG. 1 in order to inspect the industrial control system for malicious packets.

In step S310, the processor 120 receives the duplicate packets (hereinafter referred to as “second packet”).

In some embodiments, the second packet is sniffed by the switching device 210. The packet format has been described above. The second packet is received and it will be inspected whether its content satisfies a condition of the rule list.

In step S320, the processor 120 reads the network protocol data and the industrial operation data of the second packet.

In some embodiments, the second packet includes the network protocol data and the industrial operation data. The network protocol data includes a third internet protocol (IP) address and a communication port. The industrial operation data includes at least one operation parameter which is described above.

In step S330, the processor 120 determines whether the second packet satisfies the rule list.

In some embodiments, the processor 120 reads the third IP address and the communication port of the second packet, and searches the third IP address and the communication port in the look-up table (as shown in TABLE 2) in order to obtain an action role of the third IP address.

Furthermore, the processor 120 reads at least one operation parameter of the second packet, which has been described above.

The processor 120 compares the third IP address, the action role of the third IP address, and the at least one operation parameter with all of the rules in the rule list. If the processor 120 determines that the content of the packet (such as the third IP address, the action role of the third IP address, and the at least one operation parameter) does not completely satisfy the rules in the rule list (for example, at least one of the action role, the first IP address, the second IP address, and the related group does not satisfy any one rule completely), it represents that the second packet has not satisfied the rule list. Therefore, in step S340, the processor 120 generates a warning signal. If the processor 120 determines in step S330 that the second packet has satisfied the rule list, the method flow will go back to step S310 and another packet will be inspected for intrusion detection. It should be noted that the intrusion method can inspect multiple packets at the same time.

Therefore, any packet received by the switching device 210 will be inspected in order to intercept the malicious packets as soon as possible.

It should be noted that the intrusion detection device and the intrusion detection method in the disclosure generate the rule list based on the information of the Information Technology (IT) and of the Operational Technology (OT), and the two aspects information is used for detecting whether the packet is the malicious packet.

In some embodiments, each rule in the rule list includes the TCP/IP information which can be used for filtering a packet according to the IP address and the communication port of the packet. Therefore, the packet which should not be replayed through the first device 220 will be blocked on the switching device 210.

Furthermore, each rule in the rule list further includes Modbus protocol information. In the case that the TCP/IP information of the packet has been passed through the first half of the rule, and if the packet is actually generated by hackers without any permission which attempts to operate the industrial device, the operation parameters of the packet can be detected and the determination (which has been described above) can be made that the packet is abnormal. The second half of the rule, i.e., the intrusion detection for the operation action of the industrial device, can be used for filtering o or blocking the packet. For example, the packet which has a value or a trend of the operation parameters out of boundary of a rule range can be blocked on the switching device 210.

As described above, the intrusion detection device and the intrusion detection method is suitable for the TCP/IP as a communication protocol and for the industrial protocol (such as Modbus) as an application layer, and the intrusion detection of the packet can be performed based on both protocols. Because the rule list includes both the IT information and the OT information for intrusion detection (which compares with the detection method of prior art and it only provides means to filter a packet based on the IT information of the packet), the present disclosure achieves the technical effects of preventing hackers' invasion from outside (such as outside of the industrial control system) (the IT information filtering) and preventing Malicious insiders' invasion from inside (such as inside of the industrial control system) (the OT information filtering), and the system security is increased.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An intrusion detection device, which is suitable for Modbus, comprising:
a connection interface;
a processor configured to receive a plurality of first packets through the connection interface, wherein the processor is configured to:
obtain a network protocol data and an industrial operation data of each of the plurality of first packets;
tag a first internet protocol (IP) address of the network protocol data with a first action role and tag a second internet protocol (IP) address of the network protocol data with a second action role respectively;
obtain a related group of the first IP address, wherein the related group comprises a first industrial device information and a second industrial device information; and
generate a rule list, wherein the rule list comprises the first action role, the first IP address, the second IP address, and contents of the related group, and wherein the first action role on the rule list corresponds to the first industrial device information and the second industrial device information.

2. The intrusion detection device of claim 1, wherein the processor is further configured to:
search a communication port of the network protocol data on a look-up table in order to tag the first IP address with the first action role and to tag the second IP address with the second action role.

3. The intrusion detection device of claim 2, wherein the processor is further configured to:
tag the second IP address with the second action role according to the first action role of the first IP address and a Purdue model.

4. The intrusion detection device of claim 1, wherein the processor is further configured to:
receive a second packet through the connection interface;
read the network protocol data and the industrial operation data of the second packet to determine whether the second packet satisfies contents of the rule list; and
generate a warning signal in response to determining that the second packet does not satisfy the contents of the rule list.

5. The intrusion detection device of claim 4, wherein the processor is further configured to:
read a third internet protocol (IP) address from the network protocol data of the second packet;
obtain a third action role of the third IP address according to a communication port of the network protocol data of the second packet;
read at least one operation parameter of the industrial operation data of the second packet; and
generate the warning signal in response to determining that the third IP address, the third action role of the third IP address, and the at least one operation parameter have not satisfied the first action role, the first IP address, the second IP address, and the contents of the related group on the rule list.

6. An intrusion detection method, which is suitable for network architecture of Modbus, comprising:
receiving a plurality of first packets and obtaining a network protocol data and an industrial operation data of each of the plurality of first packets;
tagging a first internet protocol (IP) address of the network protocol data with a first action role and tagging a second internet protocol (IP) address of the network protocol data with a second action role respectively;
obtaining a related group of the first IP address, wherein the related group comprises a first industrial device information and a second industrial device information; and
generating a rule list, wherein the rule list comprises the first action role, the first IP address, the second IP address, and contents of the related group, and wherein the first action role on the rule list corresponds to the first industrial device information and the second industrial device information.

7. The intrusion detection method of claim 6, further comprising:
searching a communication port of the network protocol data on a look-up table in order to tag the first IP address with the first action role and to tag the second IP address the second action role.

8. The intrusion detection method of claim 7, further comprising:
tagging the second IP address with the second action role according to the first action role of the first IP address and a Purdue model.

9. The intrusion detection method of claim 6, further comprising:
receiving a second packet acquired by a switching device;
reading the network protocol data and the industrial operation data of the second packet to determine whether the second packet satisfies contents of the rule list; and; and
generating a warning signal in response to determining that the second packet does not satisfy the contents of the rule list.

10. The intrusion detection method of claim 9, further comprising:
reading a third internet protocol (IP) address from the network protocol data of the second packet;
obtaining a third action role of the third IP address according to a communication port of the network protocol data of the second packet;
reading at least one operation parameter of the industrial operation data of the second packet; and
generating the warning signal in response to determining that the third IP address, the third action role of the third IP address, and the at least one operation parameter have not satisfied the first action role, the first IP address, the second IP address, and the contents of the related group on the rule list.
